(19) United States
(12) Patent Application Publication
(10) Pub. No.: US 2026/0350334 A1
(43) Pub. Date: Nov. 5, 2026

(54) MANAGEMENT APPARATUS, CONTROL METHOD FOR MANAGEMENT APPARATUS, AND STORAGE MEDIUM

(71) Applicant: CANON KABUSHIKI KAISHA, Tokyo (JP)

(72) Inventor: KENTARO TAKAHASHI, Tokyo (JP)

(21) Appl. No.: 19/659,805

(22) Filed: Apr. 27, 2026

(30) Foreign Application Priority Data
May 1, 2025 (JP) 2025-076471

(51) Int. Cl. G06K 15/00; G06Q 50/18

(52) U.S. Cl. CPC G06K 15/407; G06K 15/002; G06Q 50/18

(57) ABSTRACT

A management apparatus manages delivery of a consumable related to an image processing apparatus, determines a capacity of a consumable to be delivered to the image processing apparatus, based on information regarding a temperature, notifies a notification destination related to the image processing apparatus of a notification that is based on the determination, and receives a change in the determined capacity of the consumable to be delivered to the image processing apparatus.

### BACKGROUND

### Field of the Technology

The present disclosure relates to a management apparatus that manages a consumable of an image processing apparatus, a control method for the management apparatus, and a storage medium.

### Description of the Related Art

A service that delivers consumables of an image processing apparatus under a fixed payment contract has become common. In the service of this type, when a remaining amount of a consumable gets low, the image processing apparatus communicates with a consumable management server, and the consumable management server arranges shipment of the consumable.

US 2023/0325129 describes a technique of automatically selecting a consumable and arranging delivery of the consumable in accordance with an installation environment or the like of an image processing apparatus.

However, the conventional technique has an issue that, in some cases, the capacity of a consumable to be delivered to the same image processing apparatus is changed without the user being informed, and in other cases, a consumable with a capacity unintended by the user is delivered.

### SUMMARY

The present disclosure is directed to providing a structure that enables a user to be informed of the capacity of a consumable to be delivered before delivery, and allows the user to incorporate the user's requirement into the capacity of a consumable to be delivered.

According to an aspect of the present disclosure, a management apparatus that manages delivery of a consumable related to an image processing apparatus, the management apparatus includes a controller including a processor and memory, the controller being configured to determine a capacity of a consumable to be delivered to the image processing apparatus, based on information regarding a temperature, notify a notification destination related to the image processing apparatus of a notification that is based on the determination, and receive a change in the determined capacity of the consumable to be delivered to the image processing apparatus.

Features of the present disclosure will become apparent from. the following description of embodiments with reference to the attached drawings. The following description of embodiments is described by way of example.

### BRIEF DESCRIPTION OF THE DRAWINGS

FIG. 1 is a diagram illustrating an example of a system according to an embodiment.

FIG. 2 is a diagram illustrating an example of a hardware configuration of an image processing apparatus.

FIG. 3 is a diagram illustrating an example of a hardware configuration of a consumable management apparatus.

FIG. 4 is a diagram illustrating an example of a software configuration of the image processing apparatus.

FIG. 5 is a diagram illustrating an example of functional configurations included in the image processing apparatus and the consumable management apparatus.

FIGS. 6A-6C are diagrams each illustrating an example of information managed by the consumable management apparatus.

FIG. 7 is a flowchart illustrating an example of processing for shipping a consumable according to a conventional technique.

FIG. 8 is a flowchart illustrating an example of processing for shipping a consumable according to a first embodiment.

FIG. 9 is a diagram illustrating an example of an e-mail informing a user of a delivery schedule of a consumable.

FIG. 10 is a diagram illustrating an example of a change screen presented by the consumable management apparatus according to the first embodiment.

FIG. 11 is a diagram illustrating an example of a HyperText Markup Language (HTML) e-mail transmitted to a user according to a second embodiment.

FIG. 12 is a diagram illustrating an example of a functional configuration of an image processing apparatus management application according to a third embodiment.

FIG. 13 is a diagram illustrating an example of a functional configuration of a printer driver in an image processing apparatus according to a fourth embodiment.

FIG. 14 is a diagram illustrating an example of a screen of the printer driver of the image processing apparatus according to the fourth embodiment.

FIG. 15 is a flowchart illustrating an example of processing of shipping a consumable according to a fifth embodiment.

FIG. 16 is a flowchart illustrating an example of processing for shipping a consumable according to a sixth embodiment.

FIG. 17 is a diagram illustrating an example of an e-mail informing a user of a delivery schedule of a consumable to be delivered in a case where the user re-enters into a contract, according to a seventh embodiment.

FIG. 18 is a diagram illustrating an example of a screen via which the user re-enters into a contract, the screen being presented by a consumable management apparatus according to the seventh embodiment.

FIG. 19 is a diagram illustrating an example of a change screen presented by a consumable management apparatus according to an eighth embodiment.

FIG. 20 is a diagram illustrating an example of a screen for registering a user's policy related to a printer consumable according to a tenth embodiment.

FIG. 21 is a diagram illustrating an example of a change screen presented by a consumable management apparatus according to an eleventh embodiment.

### DESCRIPTION OF THE EMBODIMENTS

Hereinbelow, embodiments for implementing the present disclosure will be described with reference to the accompanying drawings.

### First Embodiment

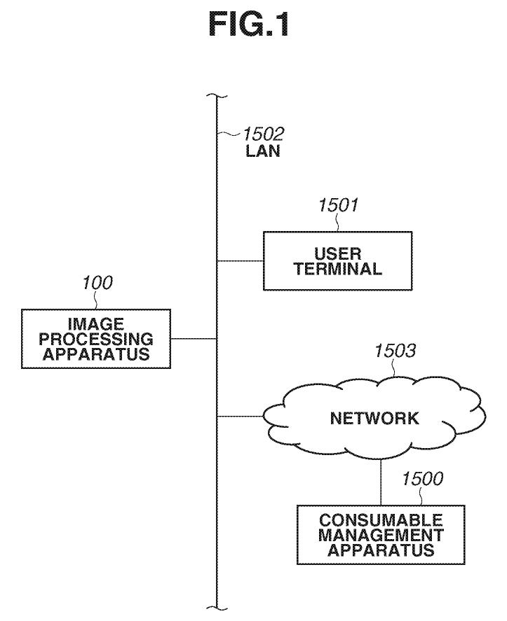

FIG. 1 is a diagram illustrating an example of a system according to an embodiment of the present disclosure.

An image processing apparatus 100 and a user terminal 1501 are connected to a local area network (LAN) 1502.

The image processing apparatus 100 and the user terminal 1501 can communicate with a consumable management apparatus 1500 via the LAN 1502 and a network 1503, such as the internet.

The image processing apparatus 100 is, for example, a printer or a multifunction peripheral (MFP) and will also be referred to as an image forming apparatus.

The user terminal 1501 is an information processing apparatus, such as a personal computer (PC), a tablet terminal, or a smartphone.

The consumable management apparatus 1500 is a server for managing the delivery of consumables by communicating with the image processing apparatus 100 via the network 1503. The consumable management apparatus 1500 may be implemented by one computer, may be implemented by a plurality of computers, or may be implemented using the technique of cloud computing, for example.

A configuration of each apparatus included in the system according to the present embodiment will be described.

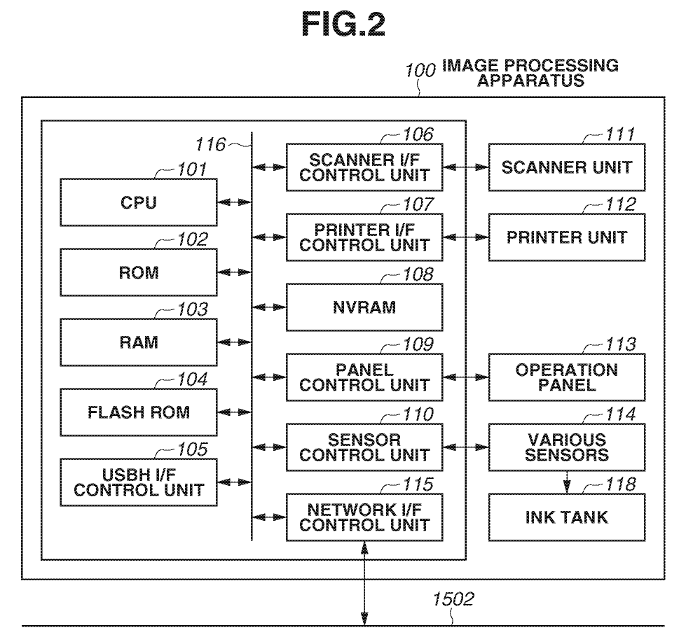

FIG. 2 is a block diagram illustrating an example of a hardware configuration of the image processing apparatus 100.

A central processing unit (CPU) 101 performs control of the entire apparatus by reading out a software program for the image processing apparatus 100 that is stored in a read-only memory (ROM) 102, a flash ROM 104, or the like, into a random access memory (RAM) 103, and executing the software program.

The ROM 102 stores a boot program, a fixed parameter, and the like for the apparatus.

The RAM 103 is used, for example, to store temporary data when the CPU 101 controls the apparatus.

The flash ROM 104 is a rewritable nonvolatile memory, and is used to store various types of data, such as installed applications, application data, and print data.

A universal serial bus host interface (USBH I/F) 105 controls a universal serial bus (USB) host interface, and controls communication with various USB devices.

A scanner interface (I/F) control unit 106 is a device for controlling a scanner unit 111.

A printer I/F control unit 107 is a device for controlling a printer unit 112.

A nonvolatile random access memory (NVRAM) 108 stores various setting values for the image processing apparatus 100.

A panel control unit 109 controls an operation panel 113 to display various types of information, and to receive an instruction input from the user.

A sensor control unit 110 is a device for controlling various sensors 114 included in the image processing apparatus 100. Examples of the sensors include a human detecting sensor for determining whether a human exists in front of the image processing apparatus 100, a sensor for detecting attachment of an ink tank 118, a sensor for detecting an ink remaining amount of the ink tank 118, and the like.

A network I/F control unit 115 controls data transmission and reception with a LAN network 1502.

The CPU 101, the ROM 102, the RAM 103, and the flash ROM 104 are connected to a bus 116. The USBH I/F 105, the scanner I/F control unit 106, the printer I/F control unit 107, the NVRAM 108, the panel control unit 109, the sensor control unit 110, and the network I/F control unit 115 are also connected to the bus 116. The bus 116 is a system bus via which control signals from the CPU 101 and data signals between units are transmitted and received.

The image processing apparatus 100 includes the ink tank 118 containing a printing agent, such as ink or toner, that is to be used for printing. The attachment, the type, and the remaining amount of the ink tank 118 are managed by the various sensors 114.

The CPU 101 can function as various units by executing programs. Control circuitry, such as an application specific integrated circuit (ASIC), that operates in cooperation with the CPU 101 may function as these units. These units may be implemented by cooperation between the CPU 101 and control circuitry that controls operations of the image processing apparatus 100. The number of CPUs 101 is not limited to one, and a plurality of CPUs 101 may be provided. In this case, a plurality of CPUs 101 can execute processing in a dispersed manner. A plurality of CPUs 101 may be arranged in a single computer, or may be arranged in a plurality of computers physically separated from each other. A unit to be implemented by the CPU 101 executing a program may be implemented by dedicated circuitry.

A hardware configuration of the consumable management apparatus 1500 will be described.

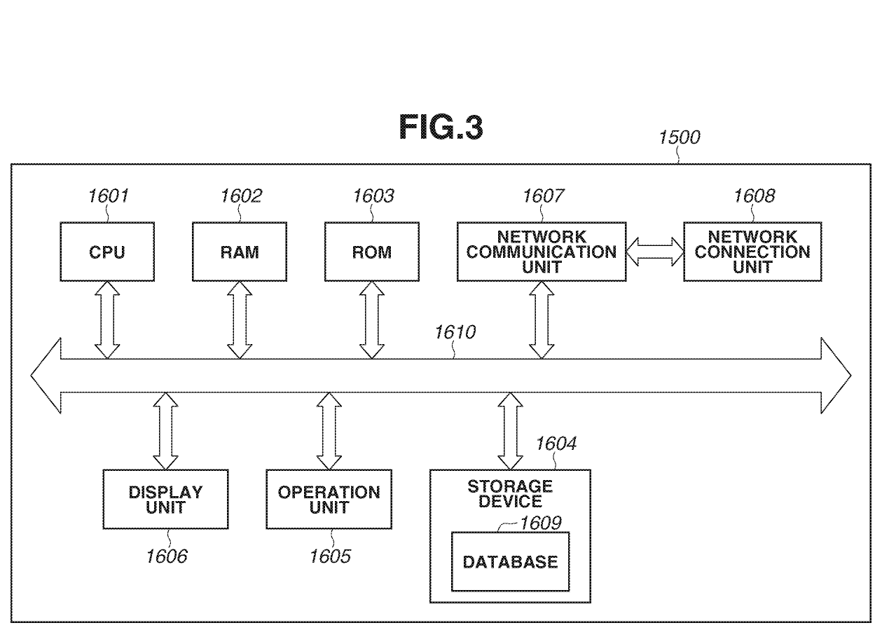

FIG. 3 is a block diagram illustrating an example of a hardware configuration of the consumable management apparatus 1500.

The consumable management apparatus 1500 includes a CPU 1601, a RAM 1602, a ROM 1603, a storage device 1604, an operation unit 1605, a display unit 1606, a network communication unit 1607, and a network connection unit 1608.

The CPU 1601 is a central processing device for controlling each component of the consumable management apparatus 1500.

The RAM 1602 serves as a working memory to be used when the CPU 1601 executes a program.

The ROM 1603 is a read-only memory for storing programs to be executed by the CPU 1601.

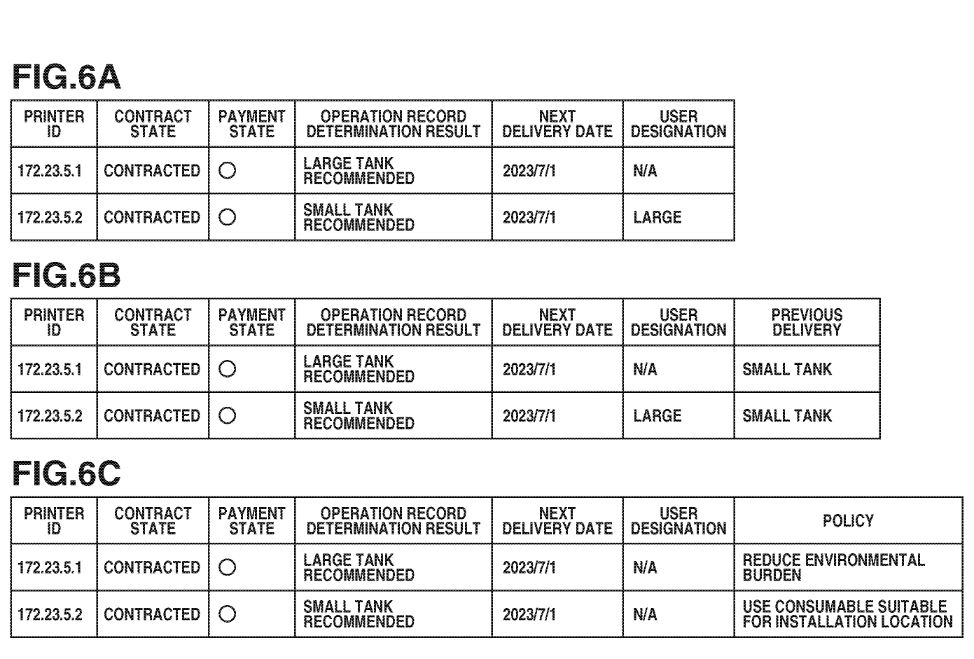

The storage device 1604 is a device for storing programs to be executed by the CPU 1601, a database 1609, and various types of information, and is a nonvolatile storage device, such as a magnetic disc and a flash memory, or the like. In the database 1609, for example, various types of information, such as information regarding a fixed payment contract for a consumable delivery service according to the present embodiment (information as illustrated in FIGS. 6A-6C to be described below is included) are stored and managed.

The operation unit 1605 includes a keyboard, a mouse, and the like via which the user performs various input operations.

The display unit 1606 includes, for example, a liquid crystal display (LCD). Various types of information are displayed on the display unit 1606 and presented to the user.

The network communication unit 1607 is connected to the network 1503, such as the internet, via the network connection unit 1608, and performs various types of communication.

The above-described components are connected to each other via a bus 1610, and can transmit and receive data to and from each other.

The user terminal 1501 has a hardware configuration similar to the consumable management apparatus 1500, and the redundant description will be omitted. Alternatively, the user terminal 1501 may have a hardware configuration different from that of the consumable management apparatus 1500. In FIG. 3, the consumable management apparatus 1500 and the user terminal 1501 include one server each, but the consumable management apparatus 1500 and the user terminal 1501 may be each formed as a server system including one or more servers.

Hereinbelow, a software configuration that is constructed on the image processing apparatus 100 will be described.

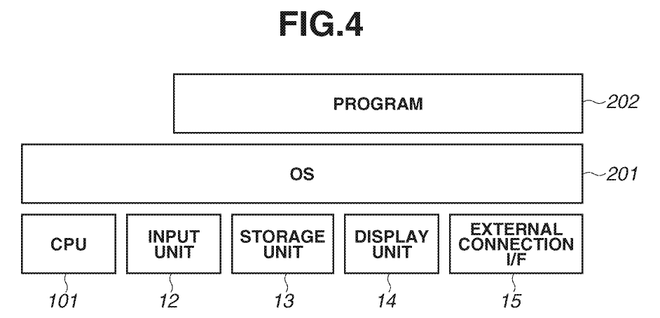

FIG. 4 is a diagram illustrating an example of a software configuration of the image processing apparatus 100.

An operating system 201 (hereinbelow, referred to as "OS 201") is software serving as a basis of the entire system.

A program 202 is software operating on the OS 201.

An input unit 12 corresponds to the scanner I/F control unit 106, the printer I/F control unit 107, and the sensor control unit 110 illustrated in FIG. 2.

A storage unit 13 corresponds to the ROM 102, the RAM 103, the flash ROM 104, and the NVRAM 108 illustrated in FIG. 2.

A display unit 14 corresponds to the panel control unit 109 illustrated in FIG. 2.

An external connection I/F 15 corresponds to the network I/F control unit 115 illustrated in FIG. 2.

This configuration is similar to that of a general computer, and the software configurations of the consumable management apparatus 1500 and the user terminal 1501 to be described below are also similar to the configuration illustrated in FIG. 4.

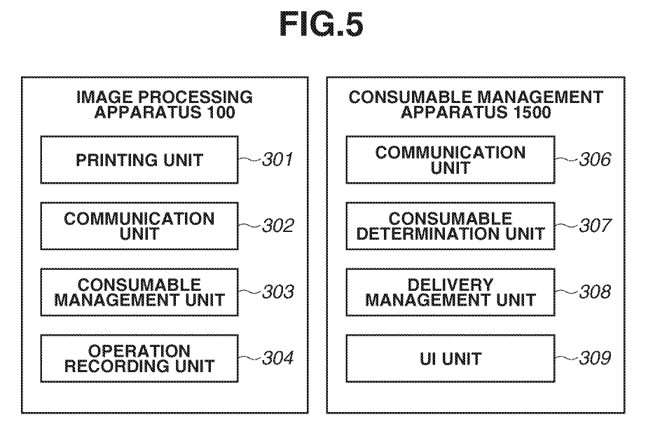

FIG. 5 is a diagram illustrating an example of functional configurations included in the image processing apparatus 100 and the consumable management apparatus 1500.

The image processing apparatus 100 includes, as the functional configuration, a printing unit 301, a communication unit 302, a consumable management unit 303, an operation recording unit 304, and the like.

The printing unit 301 executes printing using the printer unit 112.

The communication unit 302 executes communication between the image processing apparatus 100 and an external device by using the network I/F control unit 115.

The consumable management unit 303 performs management of ink or toner of the image processing apparatus 100.

The operation recording unit 304 performs management by recording operation record information, such as a temperature and an error, during an operation of the image processing apparatus 100.

These functional units 301 to 304 are implemented by the CPU 101 of the image processing apparatus 100 executing the program 202 on the OS 201.

The consumable management apparatus 1500 includes, as the functional configuration, a communication unit 306, a consumable determination unit 307, a delivery management unit 308, and a user interface (UI) unit 309.

The communication unit 306 executes communication between the consumable management apparatus 1500 and an external device using the network communication unit 1607.

The consumable determination unit 307 determines the type of a consumable to be delivered, with reference to operation record information notified from the image processing apparatus 100.

The delivery management unit 308 manages delivery of a consumable determined by the consumable determination unit 307.

The UI unit 309 provides a response via a screen as a user interface (UI) in accordance with an access from the user. The UI unit 309 corresponds to a general web server function or the like.

These functional units 306 to 309 are implemented by the CPU 1601 of the consumable management apparatus 1500 reading out programs stored in the ROM 1603, the storage device 1604, and the like into the RAM 1602, and executing the programs.

FIG. 6A is a diagram illustrating an example of information that is stored in the storage device 1604 of the consumable management apparatus 1500 and managed by the consumable determination unit 307 according to the first embodiment.

The consumable determination unit 307 manages, for each printer ID, which is unique information for identifying the image processing apparatus 100, information about the image processing apparatus 100, such as a contract state, a payment state, an operation record determination result, and a next delivery date, and a designation from the user. Here, the contract refers to a fixed payment contract for a consumable delivery service. The operation record determination result is a determination result of a recommended type of a consumable that has been determined with reference to an operation record of the image processing apparatus 100.

Here, as an example, a case in which the ink tank 118 to be attached to the image processing apparatus 100 includes two types: "large" and "small" will be described.

While using a large ink tank reduces an ink tank replacement frequency and delivery cost, the large ink tank has an issue that, due to deterioration of an airflow in the image processing apparatus 100, a temperature in the image processing apparatus 100 gets high during printing, causing an operation of the image processing apparatus 100 to be unstable. Due to such properties, it is necessary to determine the type (large/small) of a consumable to be shipped.

Processing of shipping a consumable according to a conventional technique will be described.

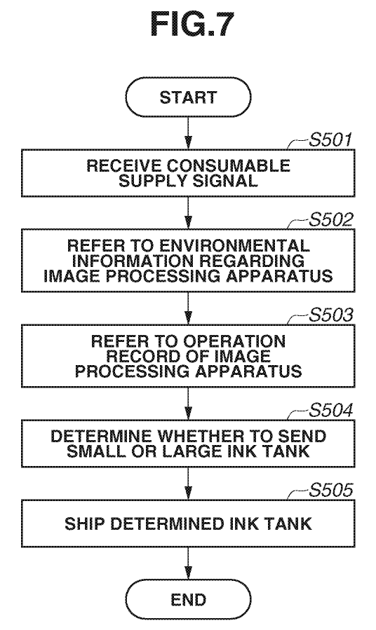

FIG. 7 is a flowchart illustrating an example of processing in which a consumable management apparatus ships a consumable according to the conventional technique.

In step S501, when a conventional consumable management apparatus receives a consumable supply signal transmitted from an image processing apparatus, the processing proceeds to step S502.

In step S502, the consumable management apparatus refers to environmental information regarding an environment where the image processing apparatus is installed. The environmental information specifically includes, for example, temperature information at an address where the image processing apparatus is installed.

Then, in step S503, the consumable management apparatus refers to operation record information regarding the image processing apparatus. Here, the operation record information specifically refers to past internal temperatures and error logs of the image processing apparatus.

Next, in step S504, the consumable management apparatus determines whether to send a small or large ink tank. In summary, in a case where the past temperature is equal to or larger than a certain value, or in a case where there is an error log due to high temperature, the consumable management apparatus determines that a "small ink tank" is to be sent, and if not, the consumable management apparatus determines that a "large ink tank" is to be sent.

Then, in step S505, the consumable management apparatus performs shipment processing of the ink tank determined in step S504 described above.

As described above, in the conventional technique, by selecting (determining) an ink tank as illustrated in FIG. 7, it is possible to deliver a consumable of a type suitable for each image processing apparatus. However, such a conventional technique can cause the user to experience that a consumable of a type different from the previous type is delivered, or to experience that a consumable of a type unintended by the user is delivered. Such an experience may create a user's feeling of dissatisfaction and lead to complaints or the like.

In view of the foregoing, in the present embodiment, a configuration for issuing a notification so that a consumable to be delivered is of a type acceptable to the user, and causing the user to perform a selection is provided. Hereinbelow, this configuration will be described.

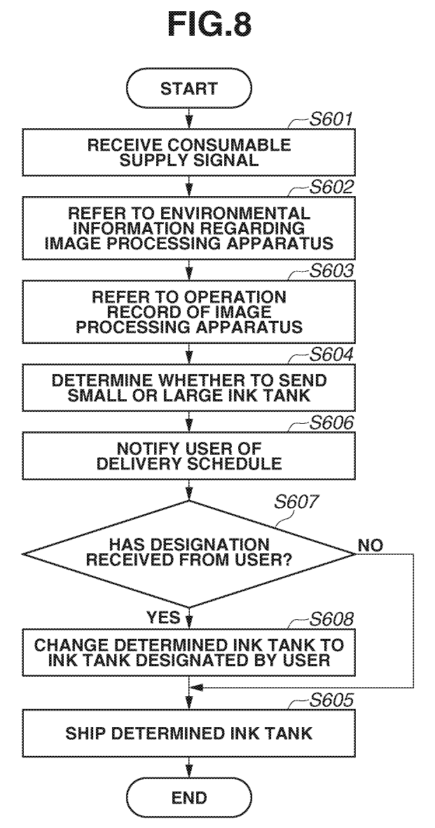

FIG. 8 is a flowchart illustrating an example of processing in which the consumable management apparatus 1500 according to the first embodiment ships a consumable. The processing in this flowchart is implemented by the CPU 1601 of the consumable management apparatus 1500 reading out a program stored in the ROM 1603, the storage device 1604, and the like, into the RAM 1602, and executing the program. In other words, the processing is implemented by functions of the consumable management apparatus 1500, illustrated in FIG. 5, or the like.

First of all, in step S601, when the consumable management apparatus 1500 receives a consumable supply signal transmitted from the image processing apparatus 100, the processing proceeds to step S602. The image processing apparatus 100 transmits a consumable supply signal to the consumable management apparatus 1500 when an ink remaining amount of the ink tank 118 falls below a predetermined threshold value, for example.

In step S602, the consumable management apparatus 1500 refers to environmental information regarding an environment where the image processing apparatus 100 is installed. The environmental information specifically includes, for example, temperature information at an address where the image processing apparatus 100 is installed.

Then, in step S603, the consumable management apparatus 1500 refers to operation record information regarding the image processing apparatus 100. Here, the operation record information specifically refers to past internal temperatures and error logs of the image processing apparatus 100. The image processing apparatus 100 acquires the above-described environmental information and operation record information periodically and/or at a predetermined timing, such as a printing execution timing or the like, and stores the acquired information in the flash ROM 104 or the like. Furthermore, the image processing apparatus 100 transmits the above-described environmental information and operation record information to the consumable management apparatus 1500 periodically and/or at the predetermined timing, such as a printing execution timing or the like. The consumable management apparatus 1500 manages information, such as environmental information and operation record information, received from the image processing apparatus 100, by storing the information in the storage device 1604 or the like of the consumable management apparatus 1500.

In the present embodiment, the consumable management apparatus 1500 may omit the processing in step S602 and refer to operation record information on the image processing apparatus 100 in step S603.

Next, in step S604, the consumable management apparatus 1500 determines whether to send a small or large ink tank. In summary, in a case where the past temperatures are equal to or larger than a certain value, or in a case where there is an error log due to high temperature, the consumable management apparatus 1500 determines that a "small ink tank" is to be sent, and if not, the consumable management apparatus 1500 determines that a "large ink tank" is to be sent.

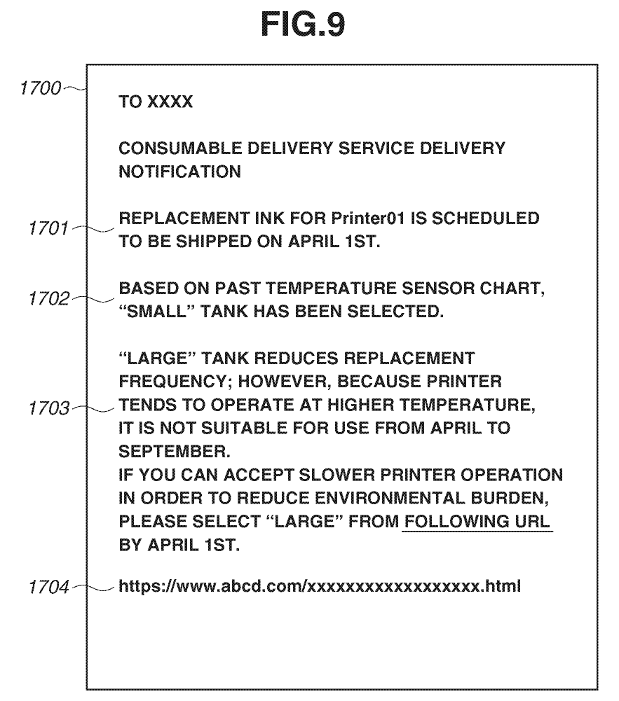

Next, in step S606, the consumable management apparatus 1500 notifies a notification destination related to the image processing apparatus 100 of a delivery schedule for the consumable determined in step S604 described above. As a generally used method of the notification, for example, an e-mail including a uniform resource locator (URL) from which a delivery schedule can be checked as illustrated in FIG. 9 is transmitted to a pre-registered notification destination of the user, but the method is not specifically limited. The notification may be issued via a communication tool or a short messaging service (SMS) for message exchange.

FIG. 9 is a diagram illustrating an example of an e-mail for informing a user of a consumable delivery schedule.

In a consumable delivery schedule notification 1700, the following are described: a scheduled shipment date 1701, a notification 1702 indicating that a "small ink tank" has been selected, a message 1703 explaining details of a reason of the selection and an influence to be exerted by selecting a "large ink tank" instead of a "small ink tank", a URL 1704 from which the above-described delivery schedule can be checked and the type of a consumable can be changed, and the like. In the consumable delivery schedule notification 1700, the above-described items 1701 to 1703 may be omitted, and the URL 1704 and a message indicating that a delivery schedule can be checked and changed from the URL 1704 may be described.

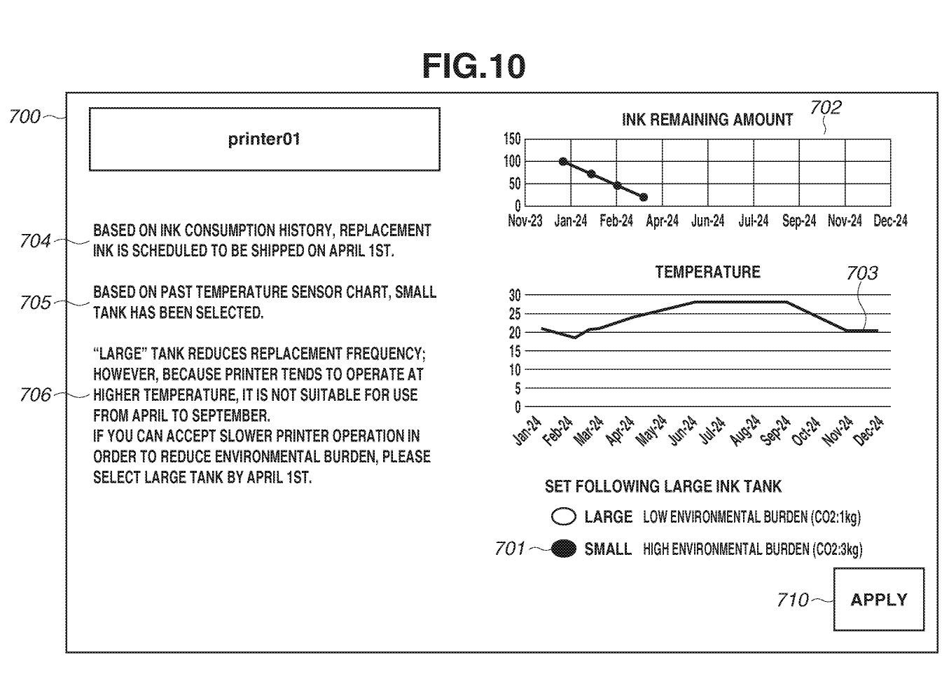

In response to an access to the URL 1704 included in the above-described consumable delivery schedule notification 1700, the consumable management apparatus 1500 provides the access source with a change screen as illustrated in FIG. 10.

FIG. 10 is a diagram illustrating an example of a change screen presented by the consumable management apparatus 1500 according to the first embodiment.

For example, in a case where an access to the URL 1704 is performed from the user terminal 1501, the consumable management apparatus 1500 transmits a change screen 700 as illustrated in FIG. 10 to the user terminal 1501. When receiving the change screen 700, the user terminal 1501 displays the change screen 700 as illustrated in FIG. 10 and receives an operation input from the user.

In the example illustrated in FIG. 10, regarding a "Printer01" owned by the user, the types of an ink tank scheduled to be delivered and UIs for changing the type are displayed as radio buttons 701. Further, a scheduled shipment date 704 is displayed, and a graph 702 of an ink remaining amount is displayed as reason for the schedule. A past temperature sensor chart 703 is displayed, and a message 705 indicating that a small ink tank has been selected based on the past temperature sensor chart 703 is displayed. A message 706 explaining the details of the reason for the selection and an influence to be exerted by selecting a "large ink tank" instead of a "small ink tank" is displayed. By displaying such a screen, the user can understand and accept the type of a consumable to be delivered.

In a case where a type of a consumable is designated using the radio buttons 701, and an apply button 710 is pressed by the user, the user terminal 1501 transmits, to the consumable management apparatus 1500, information (user designation information) regarding the type of the consumable designated using the selected one of the radio buttons 701.

After step S606 described above, in step S607, the consumable management apparatus 1500 waits for user designation. In a case where the above-described user designation information has not been received by a shipment deadline that is based on the scheduled shipment date 704, the consumable management apparatus 1500 determines that user designation has not been performed (NO in step S607), and the processing proceeds to step S605.

On the other hand, in a case where the above-described user designation information has been received by the above-described shipment deadline, the consumable management apparatus 1500 determines that user designation has been performed (YES in step S607), and the processing proceeds to step S608.

In step S608, the consumable management apparatus 1500 changes the type of a consumable to be delivered that has been determined in step S604 described above to a type designated by the user (type of a consumable indicated by the above-described user designation information), and the processing proceeds to step S605.

In step S605, the consumable management apparatus 1500 performs shipment processing of a consumable (ink tank in this example) of the type determined in steps S604 to S608 described above.

As described above, in the first embodiment, the function of issuing a notification and causing the user to perform a selection to deliver a consumable of a type acceptable to the user is implemented. With this configuration, the user can be informed of the type of a consumable to be delivered, before delivery, and a user's requirement can be incorporated into the type of a consumable to be delivered. In other words, changing the type of consumables to be delivered to the same image processing apparatus without the user being informed is prevented (for example, a tank is prevented from being changed from a large tank to a small tank without permission). Further, a consumable of a type intended by the user is delivered. Accordingly, customer satisfaction of the user is improved, and consequently, it becomes possible to suppress complaints from the user.

### Second Embodiment

In the above-described first embodiment, a UI for receiving an instruction from the user is displayed on a screen displayed in response to the user accessing the consumable management apparatus 1500 (e.g., FIG. 10). To receive an instruction from the user more simply, it is desirable to send an e-mail to the user and to enable the user to issue an instruction on a screen displaying the e-mail. In a case of using the e-mail in a hypertext markup language (HTML) e-mail format, an instruction can be received from a screen displaying the e-mail. In view of the foregoing, a method of sending an HTML e-mail to the user and causing the user to designate a type of a consumable on a screen of the e-mail will be described as the second embodiment.

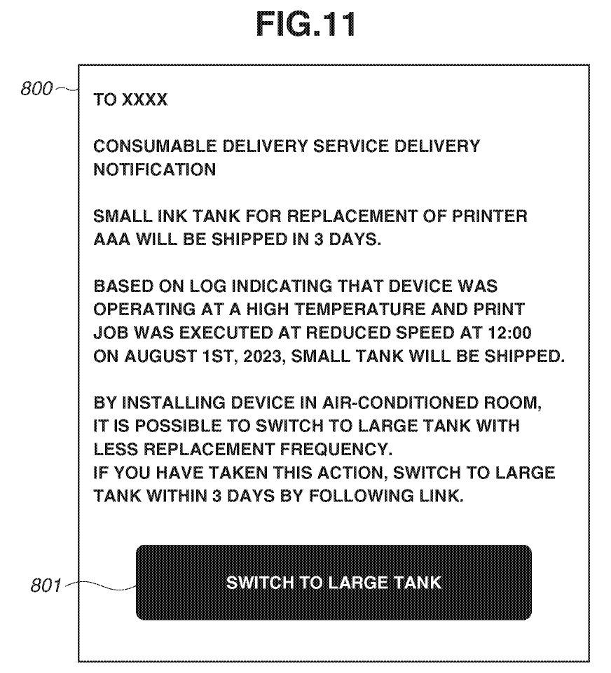

FIG. 11 is a diagram illustrating an example of an HTML e-mail 800 to be sent to the user in the second embodiment. In the present embodiment, in step S606 of FIG. 8, an e-mail like the HTML e-mail 800 is sent.

In the HTML e-mail 800, information similar to the information illustrated in FIG. 10 is displayed as text, and a button 801 for designating a type of a consumable to be delivered is displayed. In other words, by receiving the HTML e-mail 800 on the user terminal 1501, a screen as illustrated in FIG. 11 is displayed on a display unit of the user terminal 1501, and a user operation can be received. In response to the user pressing the button 801, an instruction (user designation information) is transmitted from the user terminal 1501 to the consumable management apparatus 1500. Accordingly, the consumable management apparatus 1500 determines that user designation has been performed (YES in step S607 of FIG. 8), and the processing proceeds to step S608. The subsequent processing is similar to that in the first embodiment, and thus the redundant description will be omitted.

As described above, according to the second embodiment, by allowing a type of a consumable to be delivered on a consumable delivery schedule notification e-mail to be changed, an effect similar to that of the first embodiment can be obtained by a simpler operation.

### Third Embodiment

In the above-described first embodiment, a UI for receiving an instruction from the user is displayed on the screen displayed in response to the user accessing the consumable management apparatus 1500. However, in a case where the user usually manages the image processing apparatus 100 using an application operating on a smartphone, by displaying the above-described UI on a screen of the application, operability is expected to be improved. In view of the foregoing, a method of issuing a notification indicating a type of a consumable to be delivered by using an application operating on a smartphone, and receiving a change in the type will be described as the third embodiment.

In the third embodiment, the user terminal 1501 will be described as a mobile terminal, such as a smartphone or a tablet terminal. In the user terminal 1501, an image processing apparatus management application is installed on a storage device, such as a flash ROM. By reading out and executing the image processing apparatus management application, a CPU of the user terminal 1501 can use and manage the image processing apparatus 100.

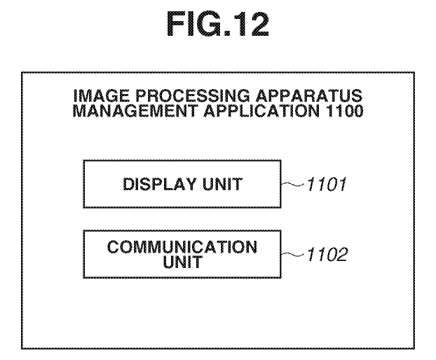

FIG. 12 is a diagram illustrating an example of a functional configuration of an image processing apparatus management application 1100 according to the third embodiment.

The image processing apparatus management application 1100 includes a display unit 1101 for displaying a screen on a display included in the user terminal 1501, and a communication unit 1102 for communicating with the image processing apparatus 100 and the consumable management apparatus 1500.

In step S606 of FIG. 8, the consumable management apparatus 1500 transmits a delivery schedule notification (including information corresponding to the items 701 to 706 on the change screen 700) of a consumable determined in step S604, to the image processing apparatus management application 1100 of the user terminal 1501. In the image processing apparatus management application 1100 of the user terminal 1501 that has received the notification, the display unit 1101 displays a screen corresponding to the screen illustrated in FIG. 10, based on the received notification, and receives a user instruction.

Alternatively, a configuration in which the image processing apparatus management application 1100 acquires the above-described notification from the consumable management apparatus 1500 by polling or the like may be employed, or a configuration in which the image processing apparatus 100 relays a notification to the image processing apparatus management application 1100 may be employed.

As described above, according to the third embodiment, by providing a method of issuing a notification of a consumable delivery schedule and allowing a selection of a consumable type by using an image processing apparatus management application operating on a smartphone, a tablet terminal, or the like, an effect similar to that of the first embodiment can be obtained by an operation via a screen of the image processing apparatus management application.

### Fourth Embodiment

In the first embodiment, the UI for receiving an instruction from the user is displayed on the screen displayed in response to the user accessing the consumable management apparatus 1500. However, in a case where the user usually uses the image processing apparatus 100 via a printer driver installed on a PC (e.g., the user terminal 1501), by displaying the above-described UI for receiving a user instruction on a screen of the printer driver, operability is expected to be improved. In view of the foregoing, a method of notifying the user of a type of a consumable to be delivered and receiving a change in the type of the consumable via a printer driver operating on a PC will be described as a fourth embodiment.

In the user terminal 1501 according to the fourth embodiment, a printer driver of the image processing apparatus 100 is installed on a storage device, such as a flash ROM. By reading out and executing the printer driver, a CPU of the user terminal 1501 uses the image processing apparatus 100.

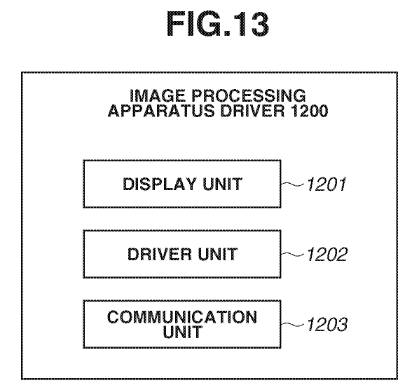

FIG. 13 is a diagram illustrating an example of a functional configuration of a printer driver 1200 (also referred to as an "image processing apparatus driver 1200") of the image processing apparatus 100 according to the fourth embodiment.

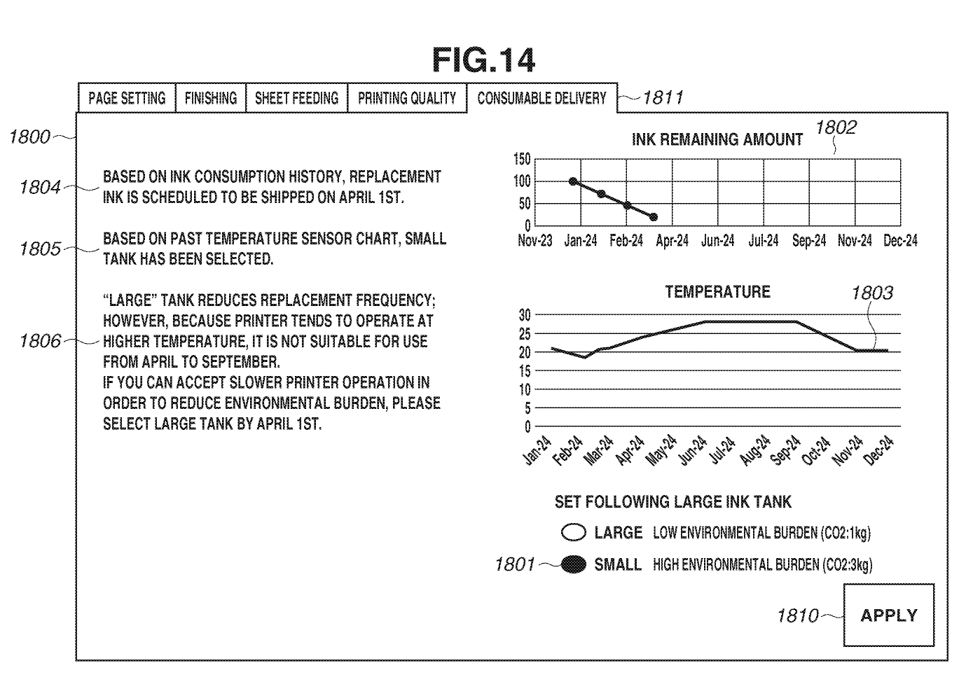

The printer driver 1200 of the image processing apparatus 100 includes a display unit 1201 for displaying a screen to be described below with reference to FIG. 14 on a display of a PC (here, the user terminal 1501), a driver unit 1202 for implementing a function of transmitting a job to the image processing apparatus 100 and a function of changing a setting, and a communication unit 1203 for communicating with the image processing apparatus 100 and the consumable management apparatus 1500.

In step S606 of FIG. 8, the consumable management apparatus 1500 transmits a delivery schedule notification (including information corresponding to items 1801 to 1806 displayed on a screen to be described below with reference to FIG. 14) to the image processing apparatus driver 1200. In the image processing apparatus driver 1200 of the user terminal 1501 that has received the notification, the display unit 1201 displays a printer driver screen 1800 as illustrated in FIG. 14 based on the received notification and receives a user instruction. A configuration in which the image processing apparatus driver 1200 acquires the above-described notification from the consumable management apparatus 1500 by polling or the like may be employed, or a configuration in which the image processing apparatus 100 relays a notification to the image processing apparatus driver 1200 may be employed.

FIG. 14 is a diagram illustrating an example of a screen of the printer driver 1200 of the image processing apparatus 100 according to the fourth embodiment.

The printer driver screen 1800 has a plurality of tabs including page setting, finishing, sheet feeding, printing quality, consumable delivery, and the like, and in response to selection of a tab, settings corresponding the selected tab can be performed. For example, in a case where a consumable delivery tab 1811 is selected, items 1801 to 1806 and 1810 corresponding to the items 701 to 706 and 710 in FIG. 10, respectively, are displayed, so that a user instruction regarding consumable delivery is receivable. In response to a selection from among radio buttons 1801 and pressing the apply button 1810, an instruction (user designation information) is transmitted from the user terminal 1501 to the consumable management apparatus 1500. Accordingly, the consumable management apparatus 1500 determines that user designation has been performed (YES in step S607 illustrated in FIG. 8), and the processing proceeds to step S608. The subsequent processing is similar to that in the first embodiment, and thus the redundant description will be omitted.

As described above, according to the fourth embodiment, by providing a method of issuing a notification of a consumable delivery schedule and selecting a consumable type using a printer driver operating on a PC, an effect similar to that of the first embodiment is easily obtainable by an operation performed on a printer driver screen.

### Fifth Embodiment

In the above-described first embodiment, a method of changing the type of the consumable determined in step S604 illustrated in FIG. 8, in accordance with an instruction of the user has been described. However, with a configuration in which the user is allowed to issue an instruction again until a consumable shipment deadline, the user can designate the type again, which may improve user convenience. In view of the foregoing, a method of enabling the user to issue an instruction again until a consumable shipment deadline will be described as the fifth embodiment.

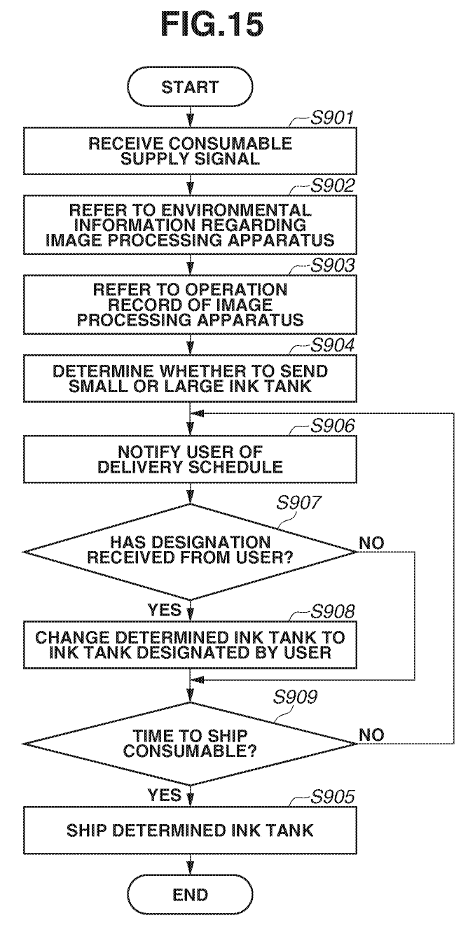

FIG. 15 is a flowchart illustrating an example of processing in which the consumable management apparatus 1500 according to the fifth embodiment ships a consumable. The processing in this flowchart is implemented by the CPU 1601 of the consumable management apparatus 1500 reading out a program stored in the ROM 1603, the storage device 1604, and the like, into the RAM 1602, and executing the program. In other words, the processing is implemented by functions of the consumable management apparatus 1500 illustrated in FIG. 5, or the like.

Steps S901 to S908 are similar to steps S601 to S608 illustrated in FIG. 8, respectively, so that the redundant description will be omitted. After the processing in step S908, and also in a case where the determination result in step S907 is NO, the consumable management apparatus 1500 according to the fifth embodiment advances the processing to step S909.

In step S909, the consumable management apparatus 1500 checks whether a certain period of time has elapsed since step S906 (or whether it is time when shipment of a consumable is required).

Here, in a case where the consumable management apparatus 1500 determines that a certain period of time has not elapsed (or it is not time when shipment a consumable is required) (NO in step S909), the processing returns to step S906. In other words, until the time at which shipment is required, a state in which an instruction is receivable again from the user is maintained. The time at which shipment is required is predicted from a remaining amount and consumption tendency of a consumable, but a prediction method is not limited to this.

On the other hand, in a case where the consumable management apparatus 1500 determines that a certain period of time has elapsed (or it is time when shipment of a consumable is required) (YES in step S909), the processing proceeds to step S905. The subsequent processing is similar to that in the first embodiment, and thus the redundant description will be omitted.

As described above, according to the fifth embodiment, with the configuration in which the user is allowed to change the type of a consumable to be delivered until a predetermined timing related to consumable delivery, the user can reissue an instruction until a consumable shipment deadline, which improves user convenience and further enhances customer satisfaction.

### Sixth Embodiment

In the above-described first embodiment, the user is informed of the type of the consumable determined in step S604 illustrated in FIG. 8.

However, if the notification is issued to the user each time, the user might feel that the notification is unnecessary.

In view of the foregoing, a method of issuing a notification only when it is determined that a consumable of a type different from the previous type is to be sent will be described as the sixth embodiment.

FIG. 6B is a diagram illustrating an example of information that is stored and managed in the storage device 1604 of the consumable management apparatus 1500 by the consumable determination unit 307 according to the sixth embodiment.

As illustrated in FIG. 6B, the consumable management apparatus 1500 according to the sixth embodiment stores and manages a type of a consumable delivered last time for each printer ID.

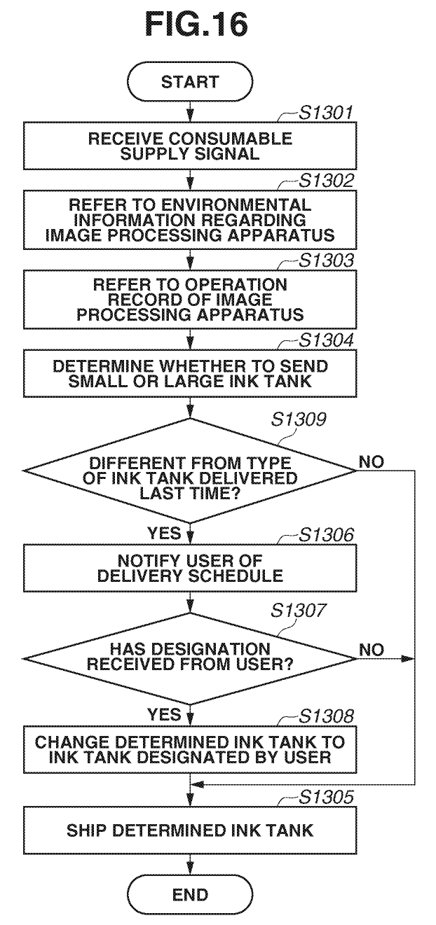

FIG. 16 is a flowchart illustrating an example of processing in which the consumable management apparatus 1500 according to the sixth embodiment ships a consumable. The processing in this flowchart is implemented by the CPU 1601 of the consumable management apparatus 1500 reading out a program stored in the ROM 1603, the storage device 1604, and the like, into the RAM 1602, and executing the program. In other words, the processing is implemented by functions of the consumable management apparatus 1500 illustrated in FIG. 5, or the like.

First of all, steps S1301 to S1304 are similar to steps S601 to S604 illustrated in FIG. 8, and thus the description will be omitted. After the processing in step S1304, the consumable management apparatus 1500 according to the sixth embodiment advances the processing to step S1309.

In step S1309, the consumable management apparatus 1500 checks whether the type determined in step S1304 described above is different from the type of a consumable delivered last time.

In a case where the consumable management apparatus 1500 determines that the determined type is the same type as the type of a consumable delivered last time (NO in step S1309), the processing proceeds to step S1305 without a notification to the user.

On the other hand, in a case where the consumable management apparatus 1500 determines that the determined type is a type different from the type of a consumable delivered last time (YES in step S1309), the processing proceeds to step S1306.

Steps S1305 and S1306 to S1308 are similar to steps S605 and S606 to S608 illustrated in FIG. 8, and thus the redundant description will be omitted.

As described above, according to the sixth embodiment, by preventing a notification from being issued when it is determined that a consumable of the same type as the type of a consumable delivered last time is to be sent, transmission of an unnecessary notification to the user is suppressed, and customer satisfaction is further enhanced.

### Seventh Embodiment

In the first embodiment, the user is informed of a type of a consumable scheduled to be delivered. However, a prerequisite fixed payment contract for a consumable delivery service may be canceled by the user. With a configuration in which the user can easily re-enter into the contract after cancellation, business sales may increase. To achieve this, it is important to resolve the user's concern on a UI screen for re-entering into the contract.

The user considering re-entering into the contract is often in a state in which a consumable on hand has run out. A concern of the user is information regarding when a consumable is to be delivered after re-entering into the contract.

In view of the foregoing, a method of displaying a consumable delivery schedule date on a screen via which the user re-enters into the contract of a consumable delivery service will be described as the seventh embodiment.

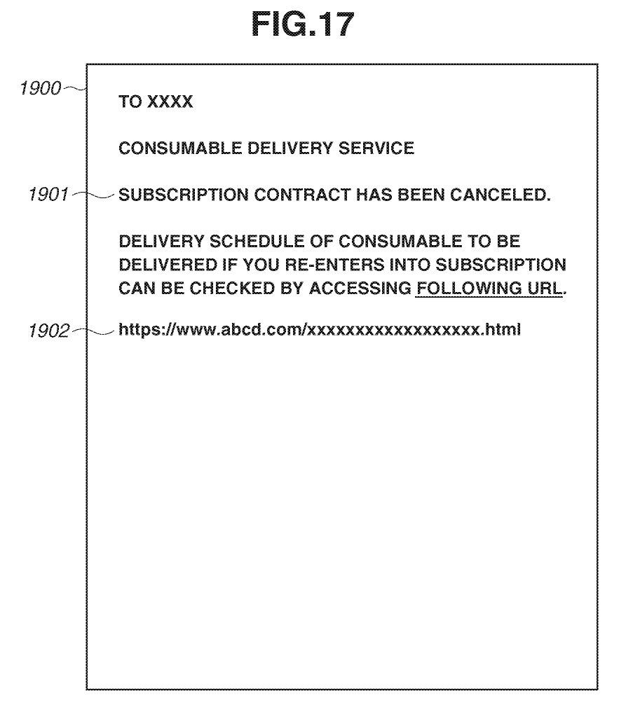

When the consumable management apparatus 1500 according to the seventh embodiment receives a consumable supply signal transmitted by the image processing apparatus 100 for which a contract of a consumable delivery service has been canceled, the consumable management apparatus 1500 performs the processing similar to the processing in steps S602 to S604 illustrated in FIG. 8, and then transmits an e-mail including a URL from which a delivery schedule of a consumable to be delivered in a case where the user re-enters into a contract, as illustrated in FIG. 17, to a pre-registered transmission destination of the user.

FIG. 17 is a diagram illustrating an example of an e-mail for informing the user of a delivery schedule of a consumable to be delivered in a case where the user re-enters into the contract, according to the seventh embodiment.

In a delivery schedule notification 1900 for a consumable to be delivered in a case where the user re-enters into the contract, a notification 1901 indicating that the contract has been canceled, a URL 1902 from which a delivery schedule of a consumable to be delivered in a case where the user re-enters into the contract can be checked, and the like are described.

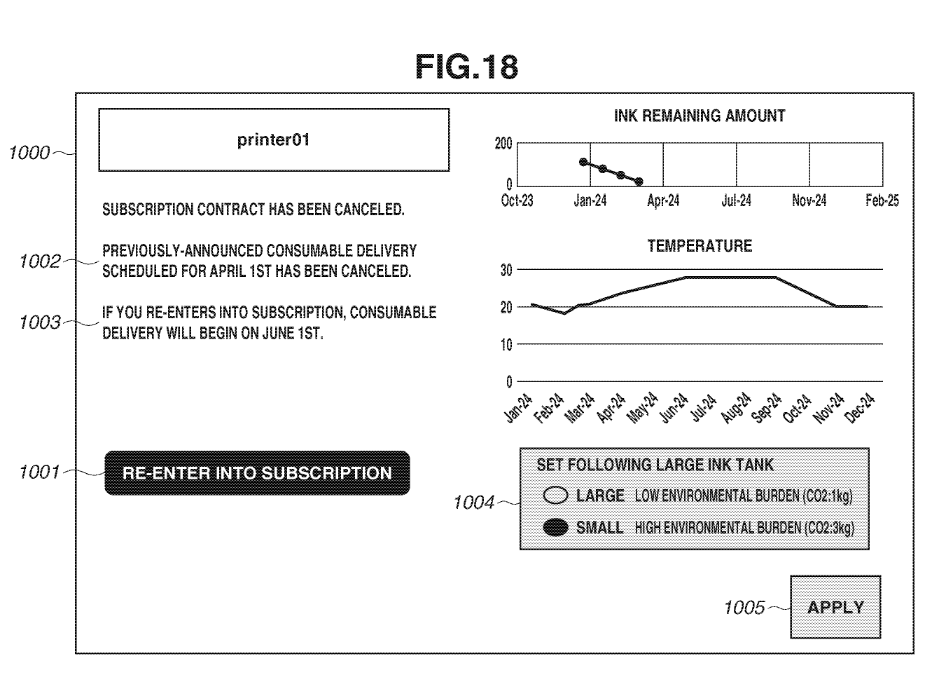

In response to an access to the URL 1902 included in the delivery schedule notification 1900 for a consumable to be delivered in a case where the user re-enters into the contract, the consumable management apparatus 1500 provides the access source with a screen for re-entering into the contract as illustrated in FIG. 18.

FIG. 18 is a diagram illustrating an example of a screen presented by the consumable management apparatus 1500 according to the seventh embodiment via which the user re-enters into the contract. This screen is displayed in response to access to the consumable management apparatus 1500 using a URL included in a delivery schedule notification for a consumable to be delivered in a case where the user re-enters into the contract.

For example, in a case where access to the URL 1902 is performed from the user terminal 1501, the consumable management apparatus 1500 transmits a screen 1000 as illustrated in FIG. 18 to the user terminal 1501. In response to receipt of the screen 1000, the user terminal 1501 displays the screen 1000 as illustrated in FIG. 18 and receives an operation input from the user.

On the screen 1000 for re-entering into the contract, a button 1001 for re-entering into the fixed payment contract, a consumable delivery state 1002 notified in the past, and information 1003 indicating when a consumable is to be delivered in a case where the user re-enters into the fixed payment contract are displayed.

A setting corresponding to the radio buttons 701 and an apply button corresponding to the apply button 710 illustrated in FIG. 10 are displayed in a disabled state by being grayed out like a setting 1004 and a button 1005, because an instruction using these items is not to be received until the user re-enters into the fixed payment contract.

Here, in a case where the button 1001 is pressed by the user, the user terminal 1501 transmits a contract re-enter request (including information for identifying the printer (e.g., printer ID)) to the consumable management apparatus 1500. In response to receipt of the contract re-enter request, the consumable management apparatus 1500 performs control to re-enter into the contract related to the corresponding printer in accordance with the request.

As described above, according to the seventh embodiment, by displaying a consumable delivery schedule date on a screen via which the user re-enters into the contract of the consumable delivery service, it is possible to prompt the user to re-enter into the contract. Since it is possible even for the user to easily re-enter into the contract at a timing at which a consumable is required, user convenience is also improved.

### Eighth Embodiment

In the above-described first embodiment, the method by which the user can change the type of a consumable scheduled to be delivered has been described. However, in many cases, a delivery date is more important for the user than a type. It is common to predict a delivery timing from a remaining amount and consumption tendency of a consumable, but a delivery timing determined from the prediction may be too late for the user who is planning to perform mass printing in a few days.

In view of the foregoing, a method by which the user can change a consumable delivery date will be described as an eighth embodiment.

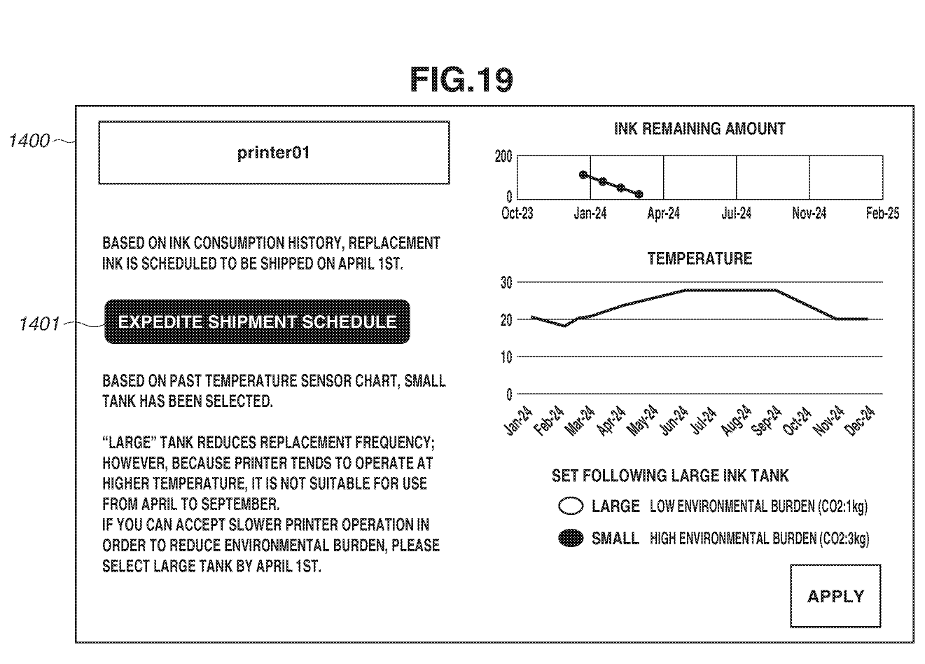

FIG. 19 is a diagram illustrating an example of a change screen presented by the consumable management apparatus 1500 according to the eighth embodiment.

For example, similarly to the change screen illustrated in FIG. 10, in a case where access to the URL 1704 is performed from the user terminal 1501, the consumable management apparatus 1500 transmits a change screen 1400 as illustrated in FIG. 19 to the user terminal 1501. In response to receipt of the change screen 1400, the user terminal 1501 displays the change screen 1400 as illustrated in FIG. 19, and receives an operation input from the user.

On the change screen 1400, a button 1401 for receiving an instruction to expedite a delivery schedule is displayed. In a case where the button 1401 is pressed by the user, the user terminal 1501 transmits a request for expediting a shipment timing (for example, including information for identifying the printer), to the consumable management apparatus 1500.

In a case where the consumable management apparatus 1500 receives the request for expediting a shipment timing, in accordance with the request, the consumable management apparatus 1500 receives an instruction to change a shipment timing of a consumable related to the corresponding printer (e.g., instruction of a desired delivery date, etc.), from the user (not illustrated), and performs control to change a shipment timing of a consumable in accordance with the instruction.

As described above, according to the eighth embodiment, the user can change a consumable delivery date, so that even in a case where mass printing is to be performed in a few days, it is possible to cope with the situation.

### Ninth Embodiment

In the above-described first embodiment, a UI for receiving an instruction from the user is displayed on the screen displayed in response to the user accessing the consumable management apparatus 1500. Alternatively, an instruction may be received from a screen of a main body of the image processing apparatus 100. The method will be described as a ninth embodiment.

The consumable management apparatus 1500 transmits a notification in step S606 illustrated in FIG. 8 to the image processing apparatus 100, and the image processing apparatus 100 displays the notification on the display unit 14.

As described above, according to the ninth embodiment, a type of a consumable scheduled to be delivered can be changed from a screen of the main body of the image processing apparatus 100.

### Tenth Embodiment

In the above-described first embodiment, a configuration in which the consumable management apparatus 1500 issues a notification of a consumable delivery schedule, and in accordance with the notification, the user can change a type of a consumable by accessing the consumable management apparatus 1500 has been described. Alternatively, a configuration in which a user's policy related to a printer consumable (policy information) is pre-registered in the consumable management apparatus 1500 in a format of a questionnaire, for example, and the consumable management apparatus 1500 determines a type of a consumable to be delivered by using the user policy information may be employed. This method will be described as a tenth embodiment.

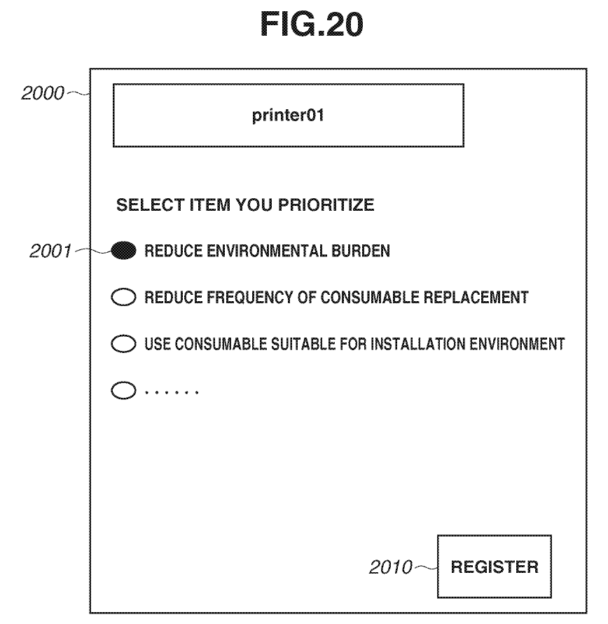

FIG. 20 is a diagram illustrating an example of a registration screen 2000 for registering a user's policy related to a printer consumable according to a tenth embodiment.

For example, when the user enters into a fixed payment contract for a consumable delivery service via the user terminal 1501, the consumable management apparatus 1500 transmits the registration screen 2000 for registering a user's tendency as illustrated in FIG. 20 to the user terminal 1501. In response to receipt of the registration screen 2000, the user terminal 1501 displays the registration screen 2000 as illustrated in FIG. 20 and receives a policy registration operation input from the user.

On the registration screen 2000, as indicated by radio buttons 2001, the selection of an item that the user prioritizes is received in a questionnaire format, for example. Examples of choices include "reduce environmental burden", "reduce frequency of consumable replacement", and "use consumable suitable for installation environment". In response to the user selecting an item to be prioritized by using the radio buttons 2001 and pressing a registration button 2010, the user terminal 1501 transmits information regarding the item designated by one of the radio buttons 2001 (information regarding a user's policy related to a printer consumable (also including information for identifying the printer)), to the consumable management apparatus 1500. In response to receipt of information regarding a user's policy related to a printer consumable, the consumable management apparatus 1500 stores and manages the information regarding the user's policy related to a printer consumable in the storage device 1604 of the consumable management apparatus 1500 in association with a printer ID of the corresponding printer.

FIG. 6C is a diagram illustrating an example of information that is stored and managed by the consumable determination unit 307 according to the tenth embodiment in the storage device 1604 of the consumable management apparatus 1500.

As illustrated in FIG. 6C, the consumable management apparatus 1500 according to the tenth embodiment stores and manages information regarding a user's policy related to a printer consumable for each printer ID.

After that, when determining a type of a consumable to be delivered, the consumable management apparatus 1500 performs determination using the above-described information regarding the user's policy related to a printer consumable. For example, in a case where the information regarding the user's policy related to a printer consumable indicates that "reduce environmental burden" or "reduce frequency of consumable replacement", the consumable management apparatus 1500 performs control to determine to deliver a "large" ink tank as the consumable to be delivered irrespective of an operation record of the printer. In a case where the information regarding the user's policy related to a printer consumable indicates that "use consumable suitable for an installation environment", the consumable management apparatus 1500 performs control to determine a consumable to be delivered, based on an operation record of the printer.

As described above, with a configuration in which a user's policy related to a printer consumable is pre-registered, a consumable intended by the user can be delivered.

### Eleventh Embodiment

In the above-described first embodiment, a configuration in which the consumable management apparatus 1500 issues a notification of a consumable delivery schedule, and in accordance with the notification, the user can change a type of a consumable by accessing the consumable management apparatus 1500 has been described. However, the type of the consumable designated by the user may be automatically applicable to subsequent deliveries, which may reduce the burden on users. The method will be described as an eleventh embodiment.

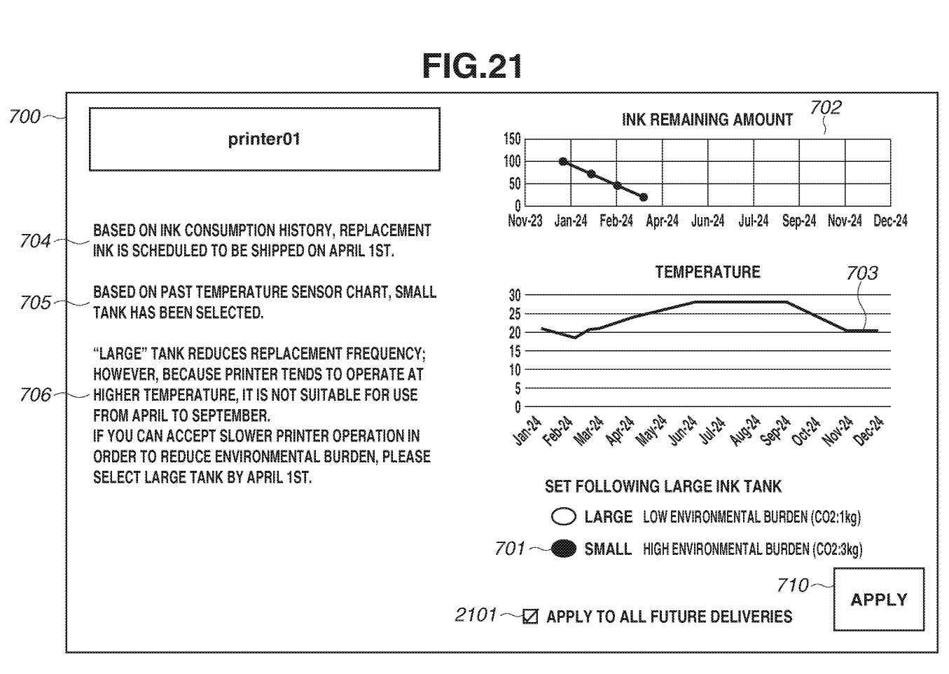

FIG. 21 is a diagram illustrating an example of a change screen 700 presented by the consumable management apparatus 1500 according to the eleventh embodiment, and the same components as those illustrated in FIG. 10 are assigned the same reference numerals.

On the change screen 700 in FIG. 21, a checkbox 2101 for applying a change performed on this screen to all future deliveries is provided.

In a case where the apply button 710 is pressed in a state in which the checkbox 2101 is checked by the user, the user terminal 1501 transmits information indicating the type of the consumable designated by one of the radio buttons 701 (user designation information) and information indicating that the checkbox 2101 is checked (checked information) to the consumable management apparatus 1500. The consumable management apparatus 1500 stores and manages the user designation information and the checked information in the storage device 1604 of the consumable management apparatus 1500 in association with information for identifying the printer.

In a case where the consumable management apparatus 1500 executes the processing illustrated in FIG. 8, the consumable management apparatus 1500 performs control to skip the processing in steps S605 to S608 illustrated in FIG. 8 when checked information is stored in association with identification information on the corresponding printer.

As described above, in a case where a type of a consumable is changed by the user, and an instruction to apply the change to subsequent deliveries is issued, it is possible to suppress transmission of an unnecessary notification to the user, which further improves usability.

In the above-described embodiments, the descriptions have been given using consumable delivery of an image processing apparatus as an example, but the present disclosure is not limited to consumable delivery of an image processing apparatus, and the present disclosure can be applied also to the delivery of a consumable for various home electronics.

As described above, according to the embodiments, by implementing a notification of a consumable to be delivered to the user, and reception of a request to change a type, it is possible to suppress an occurrence of a situation where a type of a consumable to be delivered to the same image processing apparatus is changed without the user being informed, and a consumable of a type unintended by the user is delivered, therefore customer satisfaction related to consumable delivery is improved and complaints from the user can be deterred.

It should be noted that the configurations and the contents of the various types of data described above are not limited thereto, and the data may be configured in various configurations and contents depending on usage and purpose.

Although one embodiment has been described above, the present disclosure can take the form of, for example, a system, an apparatus, a method, a program, or a storage medium. Specifically, the present disclosure may be applied to a system including a plurality of devices, or may be applied to an apparatus including a single device.

Further, all configurations obtained by combining the above embodiments are also included in the present disclosure.

### Other Embodiments

The present disclosure can also be implemented by a process in which a program for realizing one or more functions of the embodiments described above is supplied to a system or an apparatus via a network or a storage medium, and one or more processors in a computer of the system or the apparatus read and execute the program. The present disclosure can also be implemented by a circuit (e.g., an ASIC) for realizing the one or more functions.

Further, the present disclosure may be applied to a system including a plurality of devices, or may be applied to an apparatus including a single device.

The present disclosure is not limited to the above embodiments, and various modifications (including organic combinations of the embodiments) are possible based on the spirit of the present disclosure, and such modifications are not excluded from the scope of the present disclosure. That is, configurations obtained by combining the embodiments described above and modifications thereof are also included in the present disclosure.

The disclosure of the present embodiment includes the following configurations, a method, and a storage medium.

Configuration 1
A management apparatus that manages delivery of a consumable related to an image processing apparatus, the management apparatus comprising: a determination unit configured to determine a type of a consumable to be delivered to the image processing apparatus, based on operation record information regarding an image processing apparatus; a notification unit configured to notify a notification destination related to the image processing apparatus of a notification that is based on a determination performed by the determination unit; and a changing unit configured to receive a change in the determined type of the consumable to be delivered to the image processing apparatus.

Configuration 2
The management apparatus according to configuration 1, wherein the notification includes information for leading to the changing unit.

Configuration 3
The management apparatus according to configuration 2, wherein the information for leading to the changing unit is a uniform resource locator (URL) for accessing the changing unit.

Configuration 4
The management apparatus according to any one of configurations 1 to 3, wherein the changing unit receives the change by presenting at least one of information indicating the type of the consumable to be delivered to the image processing apparatus determined by the determination unit, information indicating a reason for the determination of the type of the consumable, and information indicating a delivery schedule of the consumable.

Configuration 5
The management apparatus according to configuration 1, wherein the notification is issued using a hypertext markup language (HTML) e-mail, and wherein the HTML e-mail includes a user interface via which the changing unit receives a change in the type of the consumable.

Configuration 6
The management apparatus according to configuration 1, wherein the notification unit issues the notification via an application in a mobile terminal managing the image processing apparatus and causes a screen of the application to display a user interface for receiving a change in the type of the consumable by the changing unit.

Configuration 7
The management apparatus according to configuration 1, wherein the notification unit issues the notification via a printer driver of the image processing apparatus and causes a screen of the printer driver to display a user interface for receiving a change in the type of the consumable by the changing unit.

Configuration 8
The management apparatus according to configuration 1, wherein the notification unit issues the notification to the image processing apparatus and causes a screen of the image processing apparatus to display a user interface for receiving a change in the type of the consumable by the changing unit.

Configuration 9
The management apparatus according to any one of configurations 1 to 3, wherein the changing unit receives another change in the type of the consumable to be delivered until a predetermined timing related to delivery of the consumable.

Configuration 10
The management apparatus according to any one of configurations 1 to 3, the management apparatus further comprising: a first management unit configured to manage a type of a consumable delivered last time, wherein, in a case where the type of the consumable to be delivered to the image processing apparatus determined by the determination unit and the type of the consumable delivered last time managed by the first management unit are the same, the notification unit does not issue the notification.

Configuration 11
The management apparatus according to configuration 1, the management apparatus further comprising: a second management unit configured to manage a contract of delivering a consumable to the image processing apparatus, wherein, in a case where the contract for the image processing apparatus has been canceled, instead of the notification, the notification unit notifies a user of a second notification for a schedule of a consumable to be delivered to the image processing apparatus in a case where the user re-enters into the contract.

Configuration 12
The management apparatus according to configuration 11, wherein the second notification includes a user interface for re-entering into the contract.

Configuration 13
The management apparatus according to configuration 1, wherein the changing unit is further configured to receive a change in a timing at which a consumable of the image processing apparatus is to be delivered.

Configuration 14
The management apparatus according to configuration 1, the management apparatus further comprising: a registration unit configured to register a policy related to delivery of a consumable to the image processing apparatus, wherein the determination unit determines a type of a consumable to be delivered to the image processing apparatus, based on the registered policy and operation record information on the image processing apparatus.

Configuration 15
The management apparatus according to configuration 1, wherein the changing unit is further configured to receive a change in the type of the consumable to be delivered to the image processing apparatus determined by the determination unit and an instruction to apply the received change to subsequent delivery of the consumable.

Method 1
A control method for a management apparatus that manages delivery of a consumable related to an image processing apparatus, the control method comprising:
   determining a type of a consumable to be delivered to the image processing apparatus, based on operation record information on the image processing apparatus;
   notifying a notification destination related to the image processing apparatus of a notification that is based on the determination performed by the determining; and
   receiving a change in the type of the consumable to be delivered to the image processing apparatus determined by the determining.

Recording Medium 1
A non-transitory computer-readable storage medium storing a program that causes a computer to control a management apparatus for managing delivery of a consumable related to an image processing apparatus, the program causing the computer to execute:
   determining a type of a consumable to be delivered to the image processing apparatus, based on operation record information on the image processing apparatus;
   notifying a notification destination related to the image processing apparatus of a notification that is based on the determination; and
   receiving a change in the determined type of the consumable to be delivered to the image processing apparatus.

According to the present disclosure, it is possible to prevent an occurrence of a situation where the capacity of a consumable to be delivered to the same image processing apparatus is changed without the user being informed, and a consumable with a capacity unintended by the user is delivered.

Embodiment(s) of the present disclosure can also be realized by a computer of a system or apparatus that reads out and executes computer executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)^{TM}), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-076471, filed May 1, 2025, which is hereby incorporated by reference herein in its entirety.

What is claimed is:

1. A management apparatus that manages delivery of a consumable related to an image processing apparatus, the management apparatus comprising:
a controller including a processor and memory, the controller being configured to:
determine a capacity of a consumable to be delivered to the image processing apparatus, based on information regarding a temperature;
notify a notification destination related to the image processing apparatus of a notification that is based on the determination; and
receive a change in the determined capacity of the consumable to be delivered to the image processing apparatus.

2. The management apparatus according to claim 1, wherein the notification includes information for leading to the change.

3. The management apparatus according to claim 2, wherein the information for leading to the change is a uniform resource locator (URL) for accessing the change.

4. The management apparatus according to claim 1, wherein the change receives the change by presenting at least one of information indicating the determined capacity of the consumable to be delivered to the image processing apparatus, information indicating a reason for the determination of the capacity of the consumable, and information indicating a delivery schedule of the consumable.

5. The management apparatus according to claim 1,
wherein the notification is issued using a hypertext markup language (HTML) e-mail, and
wherein the HTML e-mail includes a user interface via which the change receives a change in the capacity of the consumable.

6. The management apparatus according to claim 1, wherein the notification is issued via an application of a mobile terminal that manages the image processing apparatus, to cause a user interface for receiving a change in the capacity of the consumable by the change to be displayed on a screen of the application.

7. The management apparatus according to claim 1, wherein the notification is issued via a printer driver of the image processing apparatus to cause a user interface for receiving a change in the capacity of the consumable by the change to be displayed on a screen of the printer driver.

8. The management apparatus according to claim 1, wherein the notification is issued to the image processing apparatus to cause a user interface for receiving a change in the capacity of the consumable by the change to be displayed on a screen of the image processing apparatus.

9. The management apparatus according to claim 1, wherein the change receives another change in the capacity of the consumable to be delivered until a predetermined timing related to delivery of the consumable.

10. The management apparatus according to claim 1, wherein the controller is further configured to:
manage a capacity of a consumable delivered last time,
wherein, in a case where the determined capacity of the consumable to be delivered to the image processing apparatus and the managed capacity of the consumable delivered last time are the same, the notifying does not issue the notification.

11. The management apparatus according to claim 1, wherein the controller is further configured to:
manage a contract of delivering a consumable to the image processing apparatus,
wherein, in a case where the contract for the image processing apparatus has been canceled, instead of the notification, the notifying notifies a user of a schedule of a consumable to be delivered to the image processing apparatus by the notification in a case where the user re-enters into the contract.

12. The management apparatus according to claim 11, wherein the notification of the schedule of a consumable to be delivered to the image processing apparatus includes a user interface for re-entering into the contract.

13. The management apparatus according to claim 1, wherein the change is further configured to receive a change in a timing at which a consumable of the image processing apparatus is to be delivered.

14. The management apparatus according to claim 1, wherein the controller is further configured to:
register a policy related to delivery of a consumable to the image processing apparatus,
wherein the determining determines a capacity of a consumable to be delivered to the image processing apparatus, based on the registered policy and operation record information on the image processing apparatus.

15. The management apparatus according to claim 1, wherein the change receives a change in the determined capacity of the consumable to be delivered to the image processing apparatus and an instruction to apply the received change to subsequent delivery of the consumable.

16. A control method for a management apparatus that manages delivery of a consumable related to an image processing apparatus, the control method comprising:
determining a capacity of a consumable to be delivered to the image processing apparatus, based on information regarding a temperature;
notifying a notification destination related to the image processing apparatus of a notification that is based on the determining; and
receiving a change in the determined capacity of the consumable to be delivered to the image processing apparatus.

17. A non-transitory computer-readable storage medium storing a program that causes a computer to control a management apparatus for managing delivery of a consumable related to an image processing apparatus, the program causing the computer to execute:
determining a capacity of a consumable to be delivered to the image processing apparatus, based on information regarding a temperature;
notifying a notification destination related to the image processing apparatus of a notification that is based on the determination; and
receiving a change in the determined capacity of the consumable to be delivered to the image processing apparatus.
